(19) United States
(12) Patent Application Publication
(10) Pub. No.: US 2024/0322194 A1
(43) Pub. Date: Sep. 26, 2024

(54) PROCESS FOR MANUFACTURING A GRAPHITE BIPOLAR PLATE BY ADHESIVELY BONDING MONOPOLAR PLATES, AND BIPOLAR PLATE AND FUEL CELL OR REDOX FLOW BATTERY COMPRISING SAME

(71) Applicant: SCHUNK KOHLENSTOFFTECHNIK GMBH, Heuchelheim (DE)

(72) Inventors: Hauke VOORMANN, Linden (DE); Dominik WITTKA, Bischoffen (DE)

(73) Assignee: SCHUNK KOHLENSTOFFTECHNIK GMBH, Heuchelheim (DE)

(21) Appl. No.: 18/576,570

(22) PCT Filed: Aug. 3, 2021
(86) PCT No.: PCT/EP2021/071691

§ 371 Date: Jan. 4, 2024

(51) Int. Cl. H01M 8/0245; H01M 8/0284; H01M 8/18

(52) U.S. Cl. CPC H01M 8/0245; H01M 8/0284; H01M 8/188

(57) ABSTRACT

A method of manufacturing a graphite bipolar plate for a fuel cell or flow battery. A pair of graphite monopolar plates is provided. The monopolar plates are bonded together along opposing contact faces of the monopolar plates. Bonding is carried out using a 1C epoxy resin. Properties of the 1C epoxy resin and/or process parameters may be specially adapted to the application. Particularly, the 1C epoxy resin is adapted to have an activation temperature of at least 50° C.

### FIELD

The present invention relates to a method of manufacturing a graphite bipolar plate as used, for example, in a fuel cell or flow battery. The invention further relates to a bipolar plate and an energy storage assembly with such a bipolar plate.

### BACKGROUND

Bipolar plates are intended to perform several different tasks for fuel cells, which are stacked to form a core of a fuel cell system. On the one hand, they are intended to interconnect adjacent fuel cells, i.e. to physically and electrically connect an anode of one cell with a cathode of an adjacent cell. On the other hand, it should be possible to distribute gas towards reaction spaces within the fuel cells across a surface of the bipolar plate, i.e. the bipolar plate should convey reaction gases into reaction zones.

For this purpose, the bipolar plate typically has flow profiles (so-called flow fields) on both sides, which may be cast and/or formed, that is to say, for example, milled or impressed, and through which hydrogen flows on one side and air or oxygen is supplied on the other side. The bipolar plate generally also controls a removal of water vapour or a release of thermal and electrical energy. Furthermore, the bipolar plate should also provide gas separation between adjacent cells, a seal to the outside and cooling if necessary.

In order to be able to meet the demands placed on it, a bipolar plate generally has an internal structure of channels through which reaction gases may be supplied or discharged. To be able to form such an internal channel structure in a manufacturing environment, the bipolar plate is usually composed of two separate monopolar plates.

The desired channel structures may be easily formed on the surfaces of one or both of the monopolar plates, which face towards each other in the assembled state to form the bipolar plate, for example in the form of elongated depressions, for example by casting or forming. The two monopolar plates may then be mechanically joined together so that the desired internal channels are formed between them due to the channel structures formed in the individual monopolar plates.

In order to meet further requirements, it has been recognised that bipolar plates may advantageously be made of a graphite material. Such a graphite material may, for example, consist of a large number of small graphite particles which are embedded in a matrix of, for example, a polymer material and/or are pressed together. The graphite material has advantageous properties for the bipolar plate, including, among others, high electrical conductivity, high thermal conductivity, good chemical resistance to the chemicals typically used in a fuel cell, sufficiently high mechanical load capacity, etc.

However, it has been recognised that the mechanical bonding of two graphite monopolar plates to form a bipolar plate is not a simple task, particularly in view of the demands placed on the bipolar plate when used in the fuel cell. The connection between the two monopolar plates should, for example, have sufficient mechanical strength, be able to withstand the thermal and chemical conditions in the fuel cell, on the one hand connect the two monopolar plates sufficiently tightly together so that, for example, no process gases may escape at unwanted points, and on the other hand have sufficient gas permeability, for example to oxygen, so that chemical processes within the fuel cell are not impeded, etc. Furthermore, it should be possible to mechanically connect two monopolar plates to manufacture the bipolar plate by means of a simple, reliable and/or cost-effective process.

Conventionally, graphite monopolar plates are often glued together in order to bond them mechanically into bipolar plates. Adhesives based on 2C epoxy resin (i.e. two-component epoxy resin), cyanoacrylates or silicone polymers are used for this purpose.

While bipolar plates bonded in the conventional way mostly meet the demands placed on fuel cells in use, it has been recognised that the manufacturing process in particular suffers from disadvantages.

### SUMMARY

Hence, there may be a need for an improved method of manufacturing a graphite bipolar plate. In particular, there may be a need for a method of manufacturing a bipolar plate which, on the one hand, meets the demands placed on a fuel cell or flow battery in use, and, on the other hand, may be realised by means of a simple, reliable and/or cost-effective process. There may also be a need for a suitably manufacturable bipolar plate and an energy storage assembly equipped therewith in the form of a fuel cell or flow battery.

Such a need may be met by the subject-matter of the independent claims. Advantageous embodiments are defined in the dependent claims, described in the following description and illustrated in the figures.

A first aspect of the invention relates to a method of manufacturing a graphite bipolar plate for a fuel cell or flow battery, the method comprising the following process steps: (i) providing a pair of graphite monopolar plates, and (ii) bonding the monopolar plates along opposing contact faces of the monopolar plates. Bonding is carried out using a 1C epoxy resin, wherein the 1C epoxy resin is adapted to have an activation temperature of at least 50° C.

A second aspect of the invention relates to a bipolar plate for a fuel cell or flow battery, the bipolar plate comprising a pair of graphite monopolar plates bonded together along opposing contact faces by means of a 1C epoxy resin, wherein the 1C epoxy resin is adapted to have an activation temperature of at least 50° C.

A third aspect of the invention relates to an energy storage assembly, in particular with at least one fuel cell or flow battery, with a bipolar plate according to an embodiment of the second aspect of the invention.

Without limiting the scope of the invention in any way, ideas and possible features relating to embodiments of the invention may be considered to be based, inter alia, on the ideas and findings described below.

Briefly and broadly summarised, a rationale for the idea described herein lies in the surprising observation that, contrary to earlier preconceptions, graphite bipolar plates may be advantageously bonded using adhesives based on 1C epoxy resin (i.e. one-component epoxy resin) in a way that is suitable for application in fuel cells or flow batteries. It has been recognised that if 1C epoxy resin is suitably adapted to the conditions existing, on the one hand, during the manufacture of the bipolar plate and, on the other hand, during the subsequent use of the bipolar plate, surprisingly, the bonding of the monopolar plates by means of such specially adapted 1C epoxy resin may be superior in many respects to bonding with adhesives conventionally used for this purpose. The 1C epoxy resin may be adapted both to join the two monopolar plates together with sufficient mechanical strength to form a bipolar plate, and to serve as a sealant to suitably seal areas within the bipolar plate or in relation to the environment of the bipolar plate. For this purpose, the properties of the 1C epoxy resin should in particular be adapted in such a way that it is sufficiently chemically resistant, gas-tight and mechanically resilient for use, for example, inside a fuel cell.

Possible details of embodiments of the methods and products proposed herein are explained below.

As already mentioned above, bipolar plates made of a graphite material may offer significant advantages when used in fuel cells or flow batteries.

As a carbon-containing material, graphite offers advantageous properties for many applications. When used in bipolar plates, for example, graphite offers very high electrical conductivity together with high thermal resilience and conductivity as well as sufficiently high mechanical strength. To form bipolar plates, graphite-containing materials are used, among others, in which graphite particles are embedded in a polymer matrix. The graphite particles give the material desired electrical and/or thermal and/or mechanical properties. The polymer matrix serves, among other things, to hold the graphite particles together mechanically and to transfer the load in the component. The polymer matrix may contain, for example, an epoxy resin. The graphite particles thus act as a filler and the polymer matrix as a type of binder. In addition to graphite particles and polymers, the material mixture may also contain other components, for example in the form of carbon black, other binding agents or similar.

Advantageously, the graphite-containing material may have a graphite content of at least 60%, preferably at least 70% or even at least 80%. The percentages may refer to the volume. Due to the high graphite content, the material may offer, among other things, very good electrical conductivity, which is particularly advantageous when used to form bipolar plates. Examples and possible properties of graphite-containing materials are described, inter alia, in the applicant's earlier patent application PCT/EP2020/078489. The graphite-containing materials described therein may be used in embodiments of the method described herein for the monopolar plates. The entire content of the earlier patent application is incorporated herein by way of reference.

In order to assemble the bipolar plate from two monopolar plates and thereby mechanically join the monopolar plates together, adhesives have been used up to now that appear ideal for such a task due to their known properties. Among others, adhesives with sufficient mechanical strength based on 2C epoxy resin, cyanoacrylate or silicone polymers are used. Such adhesive systems may, for example, be activated thermally, hygroscopically or by means of UV radiation. 2C epoxy resin is made up of two components that are mixed together shortly before processing. The two components then react chemically with each other, causing the adhesive to cure. 2C epoxy resin is known as an adhesive that may be processed in a defined way and that achieves very high strength after curing. Furthermore, due to its chemical properties, 2C epoxy resin appears to be suitable as an adhesive for bonding monopolar plates. The same applies to adhesives based on cyanoacrylate or silicone polymers.

However, it has been observed that the aforementioned, conventionally used adhesives often suffer from disadvantages with regard to their processability. For example, such adhesives often have a short pot life, so they may only be stored for a short time and must be processed quickly. Furthermore, such adhesives may take a relatively long time to cure. When processing conventionally used adhesives, narrow process windows must generally be adhered to, which may limit processability. Among other things, the chemical reaction of the two components of the adhesive releases significant amounts of thermal energy which may cause the adhesive to heat up considerably, thereby causing overheating or even a fire hazard if, for example, excessive amounts of adhesive are accidentally mixed together. Furthermore, the aforementioned adhesives often have low viscosity and thus poor stability. Moreover, such adhesives may be difficult to apply. Some of the aforementioned adhesives even contain catalyst poisons, for example as fillers, which may damage catalysts used in fuel cells, for example. Some of the aforementioned adhesives also have low final strength, in particular insufficient cohesion and/or adhesion. Use of the adhesives employed up to now may therefore be associated with high process costs and/or require an elaborate process infrastructure, involving, for example, the maintenance of a precise storage temperature and/or processing temperature, avoidance of daylight, etc.

In principle, adhesives based on 1C epoxy resin have long been known. With a 1C epoxy resin, all components are already mixed prior to application and placed in a single container. At room temperature this mixture is chemically inactive or cross-links only very slowly (latently). Therefore, activation is not achieved through mixing with another component. Rather, activation is achieved by introducing activation energy. Activation energy is typically introduced thermally, that is to say, by adding heat. Depending on its precise chemical composition, the 1C epoxy resin generally has to be heated to above an activation temperature. Above this activation temperature a typically exothermic chemical reaction begins, which leads on the one hand to the curing of the adhesive and on the other hand to the release of further thermal energy.

A long-held preconception up to now has been that, although adhesives based on 1C epoxy resin have certain advantages with regard to, for example, their processability, they only appear suitable for specific applications due to certain other properties. For example, such adhesives are used in vehicle construction to bond components together over considerable gap widths of, for example, more than 1 mm. During such bonding processes, the prevailing temperatures usually have to remain relatively low due to the materials of the components to be bonded, which may be guaranteed with conventional 1C epoxy resins due to their typically slow exothermic reaction. It is usually accepted that the adhesive takes a relatively long time to cure.

In particular, it has been assumed up to now that adhesives based on 1C epoxy resin do not have suitable or even advantageous properties for bonding monopolar plates to form a bipolar plate. Instead, it has been assumed that the typically slow curing of such adhesives has significant disadvantages for the production of bipolar plates.

Contrary to such preconceptions, it has now been recognised that adhesives based on 1C epoxy resin may be entirely suitable and even advantageous for use in bonding monopolar plates if their chemical composition and thus their physical properties are suitably adapted and/or if process parameters are suitably adapted during their processing. In particular, it has been recognised that such adhesives may be highly suitable for bonding together monopolar plates based on graphite-containing material, as these have physical properties that may be used to advantage in such bonding processes.

In particular, it has been recognised that the chemical composition of 1C epoxy resin may be adapted to withstand relatively high temperatures. At such high temperatures, the 1C epoxy resin is able react relatively quickly and thus cure. However, it had previously been assumed that 1C epoxy resin should not be heated excessively, as otherwise, due to the more intense exothermic reaction that then occurs, a very rapid further rise in temperature usually takes place within the resin, such that temperatures of several hundred degrees Celsius may be reached in conventional applications, which usually causes thermal damage to the resin.

However, as explained in more detail below, in the application described here for bonding monopolar plates, the physical properties, particularly the thermal properties, of these monopolar plates may be used to advantage in that thermal energy may be quickly dissipated to prevent excessive heating of the resin.

According to an embodiment, the 1C epoxy resin is adapted to withstand temperatures up to a limit temperature of at least 200° C. without damage. Furthermore, the 1C epoxy resin is heated to at least 200° C. during the bonding process.

In fact, adhesives based on 1C epoxy resin have typically not been designed to withstand high temperatures until now. Instead, the composition of conventional 1C epoxy resins is usually optimised with regard to other properties of the adhesive, such that the resin often starts to degrade due to thermal damage at temperatures below 180° C., often even below 160° C. However, this may be of secondary relevance in many previous fields of application of 1C epoxy resins, as higher temperatures already have to be avoided for other reasons.

But when using 1C epoxy resin for bonding monopolar plates as described herein, higher temperatures may be acceptable, in particular because the graphite monopolar plates may withstand high temperatures without experiencing problems.

Accordingly, it has been found advantageous to modify the composition of the 1C epoxy resin to allow it to withstand higher temperatures without significant thermal degradation. In particular, the composition of the resin should be adapted in such a way that it may withstand temperatures up to a limit temperature without damage. This limit temperature should preferably be at least 200° C., more preferably at least 210° C. or even at least 220° C. The thermal resistance of the epoxy resin may be influenced in different ways. For example, various amine hardeners that have aromatic or aliphatic structures along the chain may be used to influence the temperature behaviour of the epoxy resin. Aromatic amines are preferred here as they act as solid hardeners and, because they melt, are highly latent. The use of catalysts such as tertiary amines, Lewis acids and bases, dicyandiamines, polyols (e.g. phenols) or dimethylaminomethylphenol and/or accelerators such as urea and imidazole may also influence the temperature behaviour of the epoxy resin.

During bonding, the 1C epoxy resin may then be heated to a temperature of at least 200° C., preferably at least 210° C. or even at least 220° C. For this purpose, for example, one or preferably both of the monopolar plates may be heated appropriately, so that the resin between these monopolar plates is heated indirectly. This heating may bring the resin above its activation temperature so as to trigger the chemical reactions that lead to curing. Since these chemical reactions take place significantly faster at high temperatures than at lower temperatures, the described increase in process temperature may cause a curing process to take place significantly faster than is conventionally the case when curing conventional 1C epoxy resins at typically lower temperatures.

However, it is necessary to avoid the 1C epoxy resin becoming excessively hot during curing due to the exothermic reactions taking place within it. In particular, it is necessary to avoid the temperature within the 1C epoxy resin exceeding the limit temperature at which irreversible damage may occur.

For this purpose, according to a more specific embodiment, the monopolar plates may be tempered during bonding to a temperature below the limit temperature of the 1C epoxy resin.

In other words, the monopolar plates may be used not only to initially heat the epoxy resin to its activation temperature or beyond, but also to dissipate excess thermal energy from the epoxy resin. Since the graphite monopolar plates typically have very good thermal conductivity, they may be used to dissipate thermal energy quickly and efficiently from the adjacent 1C epoxy resin, in particular provided the thickness of the adhesive layer is less than 200 μm, preferably less than 150 μm, and the amount of adhesive applied is less than 0.4 g/m². In particular, the monopolar plates may be tempered or cooled in such a way that their temperature and the temperature of the adjacent epoxy resin remain below the limit temperature and thus there is no significant thermal damage to the epoxy resin.

According to an embodiment, the 1C epoxy resin may be adapted to cure at a temperature of at least 200° C. within less than 1 minute, preferably less than 30 seconds.

In other words, the composition of the 1C epoxy resin may be optimised so as to withstand relatively high process temperatures on the one hand and to cure very quickly at such high process temperatures on the other hand. It has been observed, for example, that temperature-resistant 1C epoxy resin may be fully or largely cured at a process temperature of 220° C. within 30 seconds or even within only 20 seconds.

Such rapid curing of the 1C epoxy resin used as adhesive may work very advantageously in the industrial production of graphite bipolar plates, as not only may the adhesive be applied quickly, but it may also cure very quickly thereafter. This can, for example, enable very quick cycle times when manufacturing the bipolar plates.

The 1C epoxy resin is adapted to have an activation temperature of at least 50° C., preferably at least 70° C. or even at least 90° C.

In other words, the chemical composition of the 1C epoxy resin may be chosen so that its activation temperature is well above typical ambient temperatures during manufacture of the bipolar plate. The activation temperature may be influenced, for example, by a type of hardener or hardeners used. For example, aromatic amines with a high melting point typically also have a high reaction onset. Latent catalysts may also be used. In the class of imidazoles, for example, a variation from 86° C. to 250° C. is possible. Typically, the catalyst/hardener is only chemically active when it is present in the molten phase.

This means that the 1C epoxy resin may be stored for a very long time at ambient temperatures without any significant curing reaction taking place. In other words, the pot life of the 1C epoxy resin may be very long. The 1C epoxy resin can, for example, advantageously remain workable for many hours, days or even weeks. Contamination or even damage to tools used for applying the resin caused, for example, by residues of hardening resin may also be minimised.

According to an embodiment, the 1C epoxy resin is adapted to have a glass transition temperature of at least 100° C., preferably at least 110° C. or even at least 125° C.

The glass transition temperature is sometimes also referred to as glass transformation temperature and indicates the temperature at which a solid glass or a solid polymer changes to a rubbery to viscous state. By adapting the 1C epoxy resin used for the bipolar plate to have a relatively high glass transition temperature, it is possible to ensure that the adhesive holding the monopolar plates together always remains sufficiently strong and does not already become rubbery or even viscous at temperatures of typically up to 90° C., which may often occur with bipolar plates in fuel cells during operation. This makes it possible to ensure that the bonded bipolar plate always retains sufficient strength at normal operating temperatures. The glass transition temperature is generally determined to a large extent by the bond density and the strengths of the individual bonds of the cured network. Short and small molecules with many active bonds leading to a high bond strength are generally preferred here.

Aromatics with several functional groups therefore usually result in a high glass transition temperature Tg.

According to one embodiment, the 1C epoxy resin is adapted to have a pot life of at least 5 hours and/or a latency of between 0° C. and 50° C.

Latency here means that the reaction between resin and hardener is so slow as to be negligible. In general this is essentially determined by the temperature. Latency may be influenced in particular by the choice of hardener and catalyst. Broadly speaking, the higher the melting point of the hardener/catalyst, the more latent the system. However, the strengths of the bonding forces of the individual constituents also play a role here. If a reactive bond opens easily, the molecule is more chemically active and reacts faster.

According to one embodiment, the 1C epoxy resin is adapted to be applied locally to a surface of the monopolar plates serving as a contact face and then to remain self-supportingly stable on this surface.

In other words, the 1C epoxy resin is adapted to have a flowability or viscosity such that it may be applied locally to the bonding surface of one of the monopolar plates and does not then flow laterally across the monopolar plate. Instead, provided no forces other than gravity are exerted on it, the applied resin should not change shape, that is to say, it should remain self-supportingly stable on the surface. Consequently, the monopolar plate together with the resin applied locally to it may be moved without the resin flowing away in the meantime. In particular, the monopolar plate may be moved, for example, from an apparatus with which the resin is applied locally to an apparatus with which the monopolar plate is pressed together with another monopolar plate. The rheology and/or self-supporting stability of the 1C epoxy resin may be influenced by various factors. For example, the viscosity may be significantly influenced by fillers (thixotropic agents) or thinners. These thinners may be reactive or chemically inert and usually have an aliphatic and therefore very mobile chain. In this respect they are comparable to a lubricant that promotes the sliding of aromatic bonds.

In particular, according to one embodiment, the 1C epoxy resin may be adapted to be structurally viscous.

Structural viscosity, also called shear thinning, is the property of a fluid to show decreasing viscosity at high shear forces. With reference to the epoxy resin described herein, the structurally viscous property means that the resin has high viscosity provided no large shear forces act on it, and is therefore very stable. Consequently, after local application to the monopolar plate, the resin may remain largely free of force and be moved with the monopolar plate until strong shear forces are subsequently exerted on the resin by pressing the monopolar plate together with another monopolar plate.

Due to these strong shear forces, the resin may then temporarily become thinner, flow across the surfaces of the monopolar plates and spread over a larger area between the two monopolar plates.

According to an embodiment, the 1C epoxy resin may be applied locally as a bead to one of the contact faces of the monopolar plates by means of a dispenser. The monopolar plates may then be pressed together with their opposing contact faces.

In other words, the resin may be applied locally by means of a dispenser in the areas of the surface of one monopolar plate that are to be bonded to the second monopolar plate.

The dispenser may function in a similar way to a spraying device, the applied resin being relatively flowable during spraying due to its preferably structurally viscous property and then remaining stable on the surface without the application of force.

However, the term “dispenser” is here to be interpreted broadly and is not limited to a spraying device, but may include any device, in particular a printing and/or application devices, with the aid of which viscous fluids may be applied to a surface locally, that is to say, confined to a point, line or area, for example.

After the resin has been applied to the contact face of one or both monopolar plates, they may be brought together and pressed onto each other. The resin may spread along the contact faces and adhere strongly to these.

According to a more specific embodiment, the monopolar plates with their opposing contact faces may be formed in such a way and the monopolar plates may be pressed together in such a way that a gap width of less than 200 μm, preferably less than 150 μm or less than 100 m or even less than 60 μm, is obtained between the contact faces.

In other words, the two monopolar plates may be configured so as to complement each other at least at their contact faces, so that, when the monopolar plates are pressed together, the contact faces come to lie very close to each other. An orthogonal distance between the contact faces corresponds to the gap width and should be as small as possible. A gap width of less than 200 m means, among other things, that there is only a small volume of epoxy resin between the two monopolar plates and that this resin is in contact with the monopolar plates over a large area. For example, the mass of epoxy resin per contact area may remain below 0.4 g/m². Consequently, heat generated in the resin during curing may be transferred to and dissipated through the monopolar plates over a large area and thus efficiently, thereby avoiding an occurrence of excessive temperatures.

According to one embodiment, the 1C epoxy resin may be free of fillers with diameters greater than 50 m.

Conventional 1C epoxy resins often have fillers in the form of small particles or hollow bodies that may be used to influence the flow behaviour, viscosity and/or thermal behaviour of the resin. However, in the application described here for bonding monopolar plates, in contrast to conventional typical applications of 1C epoxy resins, very narrow gap widths are aimed for, therefore it is preferable to use resin without fillers or at most with fillers of small diameter. Fillers that exhibit deformability may possibly be used, particularly in the case of bonding two monopolar plates and the forces exerted in the process.

According to one embodiment, the 1C epoxy resin may be specifically adapted with regard to certain structural and/or functional properties so as to take account of conditions or requirements such as those to be considered when used in bipolar plates for fuel cells or flow batteries. In particular, the 1C epoxy resin may be substantially free of catalyst poisons affecting catalysts used in the fuel cell. Alternatively or additionally, the 1C epoxy resin may be substantially free of substances that promote corrosion of materials used in the fuel cell or that promote membrane degradation.

Alternatively or additionally, the 1C epoxy resin may be substantially free of substances that reduce proton conductivity in the fuel cell. Alternatively or additionally, the 1C epoxy resin may have an oxygen permeability of at least 0.003 mol/s at a diffusion distance greater than 1.5 mm and a temperature in a range of 25° C. to 90° C. Alternatively or additionally, the 1C epoxy resin may be resistant to 0.5 mM sulphuric acid, glysantin and deionised water at 95° C. over 1000 hours.

In fuel cells or flow batteries, catalysts are usually used to support chemical reactions that occur there. However, the effect of such catalysts may be inhibited by certain other substances called catalyst poisons. It may therefore be important to ensure that no significant amounts of catalyst poisons circulate anywhere in the fuel cell or flow battery, including its bipolar plates. “Substantially free of catalyst poisons” or “significant amounts of catalyst poisons” may be understood here to mean that any amount of catalyst poisons within the 1C epoxy resin is at most of a size such at that the catalyst poisons do not have any significant negative effect on the functioning of the fuel cell or flow battery. Organic materials such as free siloxanes, phthalates, amides or similar substances may act as catalyst poisons in fuel cells or flow batteries. The concentration of each in the 1C epoxy resin should if possible be less than 50 ppm, preferably less than 30 ppm. An overall concentration of semi-volatile organic materials should preferably be less than 300 ppm, more preferably less than 100 ppm.

A concentration of volatile and/or flammable organic materials such as alcohols should preferably be less than 10 ppm, more preferably less than 5 ppm. Such concentrations may be measured, for example, with measurement methods such as gas chromatography/mass spectrometry (GC/MS) using DCM/methanol extraction (MSQS), EPA 8270D, TBC. Anions such as chlorides may also act as catalyst poisons. Their content should preferably be less than 10 ppm, more preferably less than 5 ppm, measured for example by measurement methods such as APHA 4110B, Ion Chromatography with Chemical Suppression of Eluent Conductivity, NIOSH 6011, APHA 4110B.

Furthermore, the properties of a fuel cell or flow battery should be prevented from deteriorating over time due to corrosion or degradation of membranes provided within it. Hence, care should also be taken with the 1C epoxy resin to ensure that it does not contain any substances that have a negative effect in this respect. For example, so-called Fenton metals should be avoided as far as possible. Such substances include, for example, iron, copper, chromium, nickel and titanium. Their concentrations in the resin should remain as far as possible less than 30 ppm, more preferably less than 10 ppm, measured for example with measuring methods such as ICP/AES, EPA 3050B.

Proton conductivity in a fuel cell should also remain high. Consequently, the 1C epoxy resin should contain as few substances as possible in as small quantities as possible that lower such proton conductivity. Such substances include, but are not limited to, aluminium, arsenic, barium, bismuth, cadmium, cobalt, lithium, magnesium, manganese, molybdenum, lead, antimony, selenium, tin, vanadium, zinc, zirconium, calcium, sodium and sulphur. Except for the three last-mentioned substances, each of these substances should if possible be present in the resin in a concentration not exceeding 30 ppm, preferably not exceeding 10 ppm, with the overall concentration of all these substances remaining as far as possible below 300 ppm, preferably below 100 ppm, measured for example with ICP/AES, EPA 3050B. Each of the three last-mentioned substances should be present in a concentration remaining preferably below 300 ppm, more preferably below 100 ppm, measured for example with PRC 7100207, EPA 3050B.

Since oxygen is required for various chemical reactions inside a fuel cell or flow battery and oxygen must, among other things, also be circulated through the bipolar plate, the oxygen permeability of the 1C epoxy resin should also be sufficiently low so as not to disrupt such circulation. In particular, oxygen should not be able to pass through, or at most negligibly pass through, a bond created by the epoxy resin and acting as a seal. The properties of the 1C epoxy resin should therefore be adapted to be largely gas-tight, especially with regard to the passage of oxygen. For this purpose, the oxygen permeability within the epoxy resin should be less than 0.006 mol/s, preferably less than 0.003 mol/s, over a distance greater than, for example, 1.5 mm. This should apply in a temperature range in which the fuel cell or flow battery is typically operated, that is to say, between 25° C. and 90° C., for example.

Furthermore, within the fuel cell or flow battery the 1C epoxy resin may come into contact with chemicals typically present there, such as sulphuric acid, glysantin and deionised water, and should therefore be resistant to them at typical operating temperatures for a sufficiently long period of time, for example at least 500 hours or even at least 1000 hours.

Embodiments of the bipolar plate according to the second aspect of the invention may be manufactured using embodiments of the manufacturing method described herein. Consequently, the 1C epoxy resin adhesive used for bonding between their monopolar plates may have the properties as described above in the method description.

An energy storage assembly according to the third aspect of the invention may comprise one or more of the bipolar plates described herein. Bipolar plates may be layered to form a stack. In addition to the bipolar plates, further components such as electrodes, membranes, etc. and/or further substances such as electrolytes may be accommodated in the energy storage assembly.

It is noted that possible features and advantages of embodiments of the invention are described herein partly with general reference to a method of manufacturing a bipolar plate and partly with reference to a bipolar plate produced in accordance with the method and the 1C epoxy resin used in the method. A person skilled in the art will recognise that the features described for individual embodiments may be transferred, adapted and/or interchanged in an analogous and suitable manner to other embodiments to arrive at further embodiments of the invention and possibly synergistic effects.

### BRIEF DESCRIPTION OF DRAWINGS

Advantageous embodiments of the invention are further explained below with reference to the accompanying drawings, in which neither the drawings nor the explanations are to be construed as limiting the invention in any way.

FIG. 1 shows a plan view of a monopolar plate during a method according to an embodiment of the present invention.

FIG. 2 shows a cross-sectional view through a monopolar plate during a method according to an embodiment of the present invention.

FIG. 3 shows another cross-sectional view through a monopolar plate during a method according to an embodiment of the present invention.

FIG. 4 shows an energy storage assembly with a fuel cell according to an embodiment of the present invention.

The figures are only schematic and not to scale. Identical reference signs in the different drawings denote identical or identically acting features.

### DETAILED DESCRIPTION

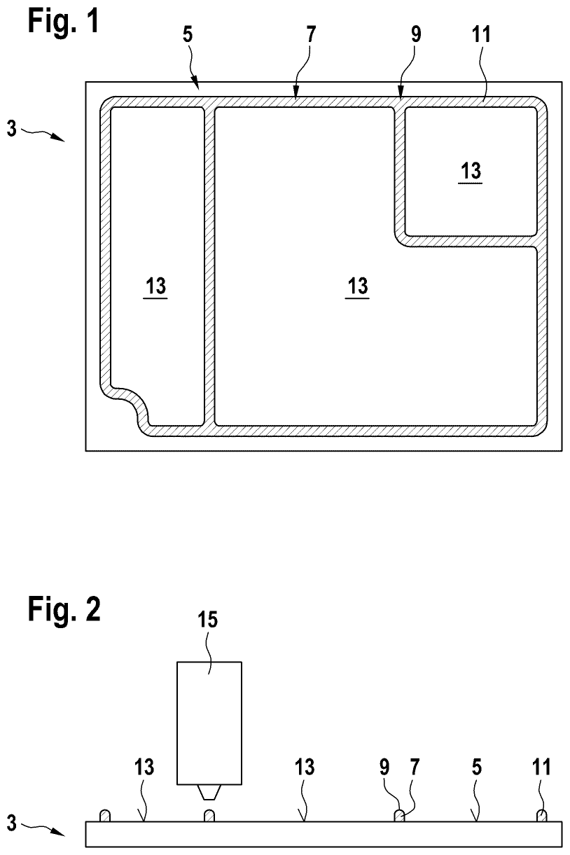

FIG. 1 shows a highly schematised plan view of a surface 5 of a monopolar plate 3, which is to be used to produce a bipolar plate for a fuel cell. In the finished bipolar plate, the surface 5 faces another monopolar plate lying opposite of similar or identical geometry. A plurality of areas 13 are present on the surface 5. Within these areas 13, channel-like structures are provided on the surface 5, for example in the form of depressions (not shown for the sake of clarity), which extend across the surface 5. A narrow linear contact face 7 runs along a periphery of each area 13 or between adjacent areas 13. Each area 13 is completely encircled by a region of this contact face 7.

As shown in the cross-section in FIG. 2, during a method in which the bipolar plate 1 is manufactured, a 1C epoxy resin 9 is first applied to the surface 5 of the monopolar plate 3 along the contact area 7 using a dispenser 15. The dispenser 15 may be of similar design to a spraying device and successively apply the 1C epoxy resin 9 in the form of a bead 11 along the contact face 7 by moving the dispenser 15 and the monopolar plate 3 relative to each other in directions parallel to the surface 5 of the monopolar plate 3. Since the 1C epoxy resin 9 is relatively tough and preferably structurally viscous, the bead 11 may be applied with a limited width of, for example, a few millimetres and a high aspect ratio (ratio of height to width) of, for example, more than 0.5. The 1C epoxy resin 9 is preferably sufficiently self-supportingly stable that the bead 11 of 1C epoxy resin 9 does not flow laterally across the surface 5 of the monopolar plate 3 after application, but retains its shape and in particular its width.

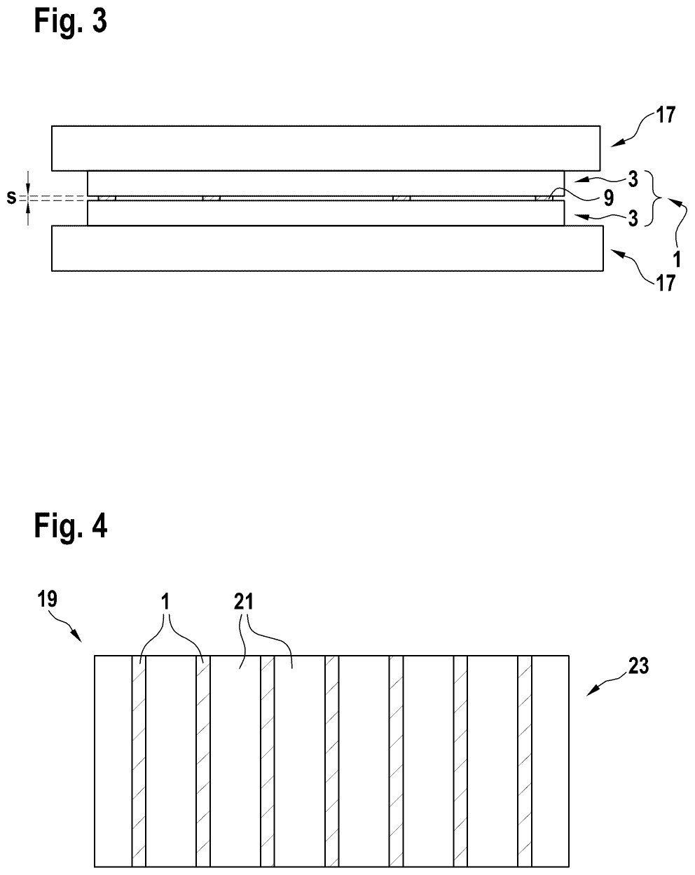

Subsequently, as illustrated in FIG. 3, the monopolar plate 3 provided with the epoxy resin 9 is stacked together with another monopolar plate 3. The stack is then placed in a heat press device 17. There, pressure is applied to the stacked monopolar plates 3 from both sides, thus pressing them together. Due to the forces exerted and in particular the resulting shear forces, the structurally viscous 1C epoxy resin flows across the surface 5. That is to say, the breadth of the contact face 7 covered by resin increases and at the same time the height of the resin layer decreases. The two monopolar plates 3 are preferably pressed towards each other to such an extent that the remaining gap width s is less than 150 μm, for example only 50 m or less.

At the same time or subsequently, the heat press device 17 is used to heat the two monopolar plates 3 to an elevated temperature of, for example, 200° C. or more. At a temperature of typically between 90° C. and 130° C., the 1C epoxy resin used in this case reaches its activation temperature, so that exothermic curing reactions begin to take place within it. The thermal energy released in the process supports the heating process. However, the heat press device 17 is designed and operated in such a way that it ensures, for example due to its thermal properties and/or even due to an active temperature control, that the monopolar plates 3 and in particular the 1C epoxy resin 9 lying between them do not become too hot, that is to say, in particular no hotter than a limit temperature above which the 1C epoxy resin may be damaged. The thermal properties of the heat press device 17 include, for example, its thermal inertia, heat capacity, thermal conductivity, etc. In addition to a heating assembly, the heat press device 17 may possibly also comprise a cooling assembly and/or sensors in order to be able to actively control or regulate its thermal behaviour. Due to the typically very high thermal conductivity of the graphite monopolar plates 3, heat energy released in the 1C epoxy resin 9 during curing may be dissipated very efficiently, thus preventing overheating.

After curing, the 1C epoxy resin 9 on the one hand ensures mechanically very resilient bonding of the two monopolar panels 3. On the other hand, the 1C epoxy resin 9 forms a type of seal around each of the areas 13.

The properties of the 1C epoxy resin 9 used for the purpose of manufacturing graphite bipolar plates 1 as described herein are specially adapted to this purpose in a variety of ways. For example, the 1C epoxy resin 9 should withstand high temperatures of at least 200° C. without damage and cure very quickly at such high process temperatures, for example within 30 seconds or less. Such an accelerated curing process allows very rapid manufacturing, that is to say, quick cycle times, in the production of bipolar plates 1. The 1C epoxy resin 9 should also have a relatively high activation temperature of, for example, more than 90° C., so that it may be stored and processed at normal ambient temperatures for a very long time, that is to say, more than 2 weeks, for example. Furthermore, the 1C epoxy resin 9 should have a relatively high glass transition temperature of, for example, more than 120° C., so that it remains solid and stable at the typical operating temperatures within a fuel cell.

It is noted that ways of influencing the properties of adhesives, in particular of 1C epoxy resins, are widely known and that experts are generally able to mix an adhesive that is suitably adapted for an application, provided they know the boundary and target conditions relevant to the application. Experts have extensive background knowledge in this field, as described for example in the textbook by Edward M. Petrie: “Epoxy Adhesive Formulations”, published by McGraw Hill Professional, 2005, ISBN 0071589082, 9780071589086, and the textbook by Sina Ebnesajjad: “Handbook of Adhesives and Surface Preparation: Technology, Applications and Manufacturing”, Plastics Design Library, published by William Andrew, 2010, ISBN 1437744621, 9781437744620.

Merely as one of many possibilities, a composition of a 1C epoxy resin is presented below, which may be used in the manufacturing method described herein. The exemplary epoxy resin consists of 50-60% resin components and 40-50% fillers.

The resin components may be composed as follows:
10-30% epichlorohydrin resin with an average molecular weight distribution not exceeding 700 (i.e. average MW<=700)
10-30% formaldehyde, oligomeric reaction product with 1-chloro, 2,3-epoxypropane and phenol
5-10% 4,4′-isopropylidenediphenol, oligomeric reaction product with 1-chloro-2,3-epoxypropane
1-5% 4,4′-isopropylidenediphenol, oligomeric reaction product with 1-chloro-2,3-epoxypropane, reaction product with [(demethyl-amino)methyl]phenol and piperazines

The fillers may be composed of 95-100% magnesium silicate and 0-5% other metal oxides.

The bipolar plate 1 manufactured in the manner described here may be used, for example, in a fuel cell 21 of an energy storage assembly 19, as shown roughly schematically in FIG. 4. In a cell stack of a fuel cell system 23 serving as an energy storage assembly 19, by means of bipolar plates 1, adjacent fuel cells 21 may be separated from each other, electrically connected to each other and supplied with fuel.

Finally, it should be noted that terms such as “having”, “comprising”, etc. do not exclude other elements or steps, and terms such as “one” or “a” do not exclude a plurality. It should further be noted that features or steps that have been described with reference to one of the above embodiments may also be used in combination with other features or steps of other embodiments described above. Reference signs in the claims are not to be considered as limitations.

### LIST OF REFERENCES

1 Bipolar plate
3 Monopolar plate
5 Surface of the monopolar plate
7 Contact face of the monopolar plate
9 1C epoxy resin
11 Bead
13 Area
15 Dispenser
17 Heat press device
19 Energy storage assembly
21 Fuel cell
23 Fuel cell system
s Gap width between monopolar plates

1-15. (canceled)

16. A method of manufacturing a graphite bipolar plate for a fuel cell or flow battery, comprising:
providing a pair of graphite monopolar plates and
bonding the monopolar plates along opposing contact faces of the monopolar plates,
wherein a 1C epoxy resin is used for bonding,
wherein the 1C epoxy resin is adapted to have an activation temperature of at least 50° C.

17. The method according to claim 16,
wherein the 1C epoxy resin is adapted to withstand temperatures up to a limit temperature of at least 200° C. without damage, and
wherein the 1C epoxy resin is heated to at least 200° C. during bonding.

18. The method according to claim 17,
wherein the monopolar plates are tempered during bonding to a temperature below the limit temperature of the 1C epoxy resin.

19. The method according to claim 17,
wherein the 1C epoxy resin is adapted to cure at a temperature of at least 200° C. within less than 1 minute.

20. The method according to claim 16,
wherein the 1C epoxy resin includes a hardener and/or a catalyst which become chemically active only upon being in a molten phase due to being heated beyond the activation temperature.

21. The method according to claim 16,
wherein the 1C epoxy resin is adapted to have a glass transition temperature of at least 100° C.

22. The method according to claim 16,
wherein the 1C epoxy resin is adapted to have a pot life of at least 5 hours and/or a latency of between 0° C. and 50° C.

23. The method according to claim 16,
wherein the 1C epoxy resin is adapted to be applied locally to a surface of the monopolar plates serving as a contact face and then to remain self-supportingly stable on this surface.

24. The method according to claim 16,
wherein the 1C epoxy resin is adapted to be structurally viscous.

25. The method according to claim 16,
wherein the 1C epoxy resin is applied by means of a dispenser as a bead locally confined to one of the contact faces of the monopolar plates and the monopolar plates are then pressed together with their opposing contact faces.

26. The method according to claim 25,
wherein the monopolar plates are formed with their opposing contact faces in such a way and the monopolar plates are pressed together in such a way that a gap width of less than 200 m is obtained between the contact faces.

27. The method according to claim 16,
wherein the 1C epoxy resin is free of fillers with diameters greater than 50 m.

28. The method according to claim 16,
wherein the 1C epoxy resin is substantially free of catalyst poisons affecting catalysts used in the fuel cell or flow battery, and/or
wherein the 1C epoxy resin is substantially free of substances that promote corrosion of materials used in the fuel cell or flow battery or that promote membrane degradation, and/or
wherein the 1C epoxy resin is substantially free of substances that reduce proton conductivity in the fuel cell or flow battery, and/or
wherein the 1C epoxy resin has an oxygen permeability of at least 0.003 mol/s at a diffusion distance greater than 1.5 mm and at a temperature in a range of 25° C. to 90° C., and/or
wherein the 1C epoxy resin is resistant to 0.5 mM sulphuric acid, glysantin and deionised water at 90° C. for at least 500 hours.

29. A bipolar plate for a fuel cell or flow battery, comprising:
a pair of graphite monopolar plates bonded together by means of a 1C epoxy resin along opposing contact faces,
wherein the 1C epoxy resin is adapted to have an activation temperature of at least 50° C.

30. An energy storage assembly, in particular with at least one fuel cell or flow battery, with a bipolar plate according to claim 29.
